(19) United States
(12) Patent Application Publication
(10) Pub. No.: US 2025/0002679 A1
(43) Pub. Date: Jan. 2, 2025

(54) MELT PROCESSABLE THERMOSET POLYMER COMPOSITIONS FOR ADDITIVE MANUFACTURING

(71) Applicant: Interfacial Consultants LLC, Prescott, WI (US)

(72) Inventors: Nathan W. Ockwig, Eagan, MN (US); Steven D. Koecher, River Falls, WI (US); Benjamin C. Mac Murray, Minneapolis, MN (US)

(21) Appl. No.: 18/757,945

(22) Filed: Jun. 28, 2024

Related U.S. Application Data
(60) Provisional application No. 63/524,281, filed on Jun. 30, 2023.

(51) Int. Cl. C08K 3/04; B29C 64/118; B29C 64/30; B29C 64/40; B29C 71/04; B29K 63/00; B29K 307/04; B33Y 10/00; B33Y 40/20; B33Y 70/00; C08K 7/06

(52) U.S. Cl. CPC C08K 3/041; B29C 64/118; B29C 64/30; B29C 64/40; B29C 71/04; B33Y 10/00; B33Y 40/20; B33Y 70/00; C08K 7/06; B29K 2063/00; B29K 2307/04; B29K 2995/0017

(57) ABSTRACT

The disclosure provides a thermally stable melt processable thermoset polymer composition including at least one melt processable thermoset polymer, such as an epoxy, and at least one reinforcing filler, such as carbon nanotubes. Such compositions when 3D printed, exhibit improved Z-layer adhesion and modulus at melt temperature, a common related additive manufacturing problem, as compared to thermoset polymers without reinforcing filler and more conventional thermoplastic resin systems. Subsequent actinic cure of such compositions irreversibly and permanently cures the material thereby making it no longer melt processable.

### CROSS-REFERENCE TO RELATED APPLICATION

This application claims priority to U.S. Provisional Application No. 63/524,281 filed Jun. 30, 2023, which is hereby incorporated by reference.

### TECHNICAL FIELD

This disclosure relates to compositions and methods for making and using a melt processable thermoset feedstock polymer composition for additive manufacturing.

### BACKGROUND

Additive manufacturing processes, commonly referred to as three-dimensional (3D) printing, can be used to construct desired objects with possible applications in numerous industries (e.g., aerospace, automotive, medical, etc.). Exemplary processes include, but are not limited to, binder jet, electron beam melting (EBM), fused deposition modeling (FDM), fused filament fabrication (FFF), ink jetting, laminated object manufacturing (LOM), selective laser sintering (SLS), selective toner electrophotographic process (STEP) and stereolithography (SL). Using such processes, a desired object can be modeled in a computer-aided design (CAD) package and printed using a selected build material. For deposition-based methods, like FDM, the selected build material is typically extruded through a heated printer in a layered manner according to computer instruction. Printing in commercially available additive manufacturing devices, like, for example, the ARBURG™ Freeformer system, often occurs in a build chamber that can provide heating and temperature control.

Many additive manufacturing techniques utilize melt processing methods to melt and extrude feedstock (e.g., pellets, filament, powders). One key limitation of this method is that the resulting mechanical properties of the printed part tend to be anisotropic. Specifically, when one measures the mechanical properties (e.g. tensile strength) of the part in the X, Y and Z direction, the Z direction properties are typically significantly less than the X and Y direction properties. This is due to the fact that the Z-axis interlayer adhesion/bonding is not as strong as the material properties in the X and Y direction. Many strategies have been attempted to improve Z-axis interlayer bonding/adhesion, but they have been unsuccessful and there is still a key need in the industry. This disclosure offers a solution to this problem. The melt processable thermosets of this disclosure chemically cure after printing and can have exceptional Z-axis interlayer bonding/adhesion as a result.

The melt processable thermoset polymer compositions of this disclosure are comprised of a melt processible thermoset polymer and a reinforcing filler. The reinforcing filler is added to increase the melt viscosity of the melt processible thermoset polymer to a level that makes it function as an effective 3D printing feedstock.

### SUMMARY

Melt processable thermoset polymer compositions, including at least one melt processable thermoset polymer (e.g., epoxy) and at least one reinforcing filler (e.g., carbon nanotubes), can solve several additive manufacturing problems: such compositions have improved z-axis interlayer bonding/adhesion, they have improved viscosity at melt processing temperatures, they have long open times at melt processing temperatures and the resulting parts have improved mechanical properties when compared to conventional thermoplastic and thermoset additive manufacturing feedstocks known in the art.

Additionally, melt processable thermoset polymer compositions can be unique in that such compositions may result in improved mechanical properties, temperature resistance, and functionality. Some embodiments have improved mechanical properties that make the melt processable thermoset polymer composition amenable for 3D printing using a pellet type printer, including modulus, storage modulus (at elevated temperatures), impact strength, tensile strength, and coefficient of thermal expansion (CTE). For example, when a melt processable thermoset polymer is melt processed with a reinforcing filler, it can produce a melt processable thermoset polymer composition with increased modulus at high temperatures, a desirable attribute for fused deposition modeling (FDM) and direct extrusion 3D printers.

In some embodiments, a melt processable thermoset polymer composition includes at least one melt processable thermoset polymer and at least one reinforcing filler. The melt processable thermoset polymer and reinforcing filler can be combined using conventional melt processing techniques such as twin-screw extrusion.

The above summary is not intended to describe each disclosed embodiment or every implementation. The detailed description that follows more particularly exemplifies illustrative embodiments.

### BRIEF DESCRIPTION OF THE DRAWINGS

FIG. 1 is an image of a melt processable thermoset polymer composition that has been 3D printed.

FIG. 2 shows the area beneath the exothermic peak after isothermally holding ScotchCast 5400 samples at different temperatures for different durations.

FIG. 3 shows the glass transition temperature after isothermally holding ScotchCast 5400 samples at different temperatures for different durations.

FIG. 4 shows the area beneath the exothermic peak after isothermally holding ScotchCast 265 samples at different temperatures for different durations.

FIG. 5 shows the glass transition temperature after isothermally holding ScotchCast 265 samples at different temperatures for different durations.

### DETAILED DESCRIPTION

Unless the context indicates otherwise the following terms shall have the following meaning and shall be applicable to the singular and plural:

The terms “a,” “an,” “the,” “at least one,” and “one or more” are used interchangeably. Thus, for example, a thermally stable melt processable thermoset polymer composition including “a” melt processable thermoset polymer means that the melt processable thermoset polymer composition may include “one or more” melt processable thermoset polymers.

The terms “additive manufacturing”, “three-dimensional printing”, “3D printing,” or “3D printed” refer to any process used to create a three-dimensional object in which successive layers of material are formed under computer control (e.g., electron beam melting (EBM), direct extrusion (DE), fused deposition modeling (FDM), ink jetting, laminated object manufacturing (LOM), selective laser sintering (SLS), selective toner electrophotographic process (STEP), and stereolithography (SL)).

The term “build chamber” refers to a volume, often enclosed, in or utilized by an additive manufacturing device within which a desired object can be printed. A non-limiting example of build chamber can be found in an ARBURG™ Freeformer (commercially available from Arburg GmbH, Lossburg, Germany).

The term “build chamber temperature” refers to the temperature provided in a build chamber during additive manufacturing.

The term “build material” refers to a material that is printed in three dimensions using an additive manufacturing process to produce a desired object, often remaining after removal of a soluble support.

The term “build plate” refers to a substrate, often a removable film or sheet, that a build material or soluble support can be printed on.

The term “composition” refers to a multicomponent material.

The term “copolymer” refers to a polymer derived, actually (e.g., by copolymerization) or conceptually, from more than one species of monomer. A copolymer obtained from two monomer species is sometimes called a bipolymer; a copolymer obtained from three monomers is sometimes called a terpolymer; a copolymer obtained from four monomers is sometimes called a quatrapolymer; etc. A copolymer can be characterized based on the arrangement of branches in the structure, including, e.g., as a linear copolymer and a branch copolymer. A copolymer can also be characterized based on how the monomer units are arranged, including, e.g., as an alternating copolymer, a periodic copolymer, a statistical copolymer, a graft copolymer, and a block copolymer.

The term “cured” refers to a chemical reaction wherein reactive species are irreversibly transformed into a crosslinked network of bonds thereby locking the material into a desired shape.

The term “feedstock” refers to the form of a material that can be utilized in an additive manufacturing process (e.g., as a build material or soluble support). Non-limiting feedstock examples include pellets, powders, filaments, billets, liquids, sheets, shaped profiles, etc.

The term “gel point” defines the time at a given temperature at which the melted thermoset resin has increased storage modulus, or complex viscosity, by a factor of 250% or greater.

The term “melt processing technique” refers to a technique for applying thermal and mechanical energy to reshape, blend, mix, or otherwise reform a polymer or composition, such as compounding, extrusion, injection molding, blow molding, rotomolding, or batch mixing. 3D printing processes that are useful in printing thermoplastic and elastomeric melt processable materials are examples of a melt processing technique.

The term “melt processable thermoset” refers to a material that is capable of being three dimensionally printed using fused deposition modeling or direct extrusion methods.

The term “melt processable thermoset polymer composition” refers to a composition that includes at least one melt processable thermoset polymer and at least one reinforcing filler, and can optionally include additives.

The term “mixing” means to combine or put together to form one single substance, mass, phase, composite, dispersion, or more homogenous state. This may include, but is not limited to, all physical blending methods, extrusion techniques, or solution methods.

The terms “polymer” and “polymeric” refer to a molecule of high relative molecular mass, the structure of which essentially contains multiple repetitions of units derived, actually or conceptually, from molecules of low relative molecular mass (monomers). The term “polymer” can refer to a “copolymer.”

The term “thermally stable” refers to a melt processable thermoset polymer composition that has open time (i.e., continues to flow and print) of at least 15 minutes at melt processing temperatures.

The recitation of numerical ranges using endpoints includes all numbers subsumed within that range (e.g., 1 to 5 includes 1, 1.5, 3, 3.95, 4.2, 5, etc.).

The melt processable thermoset polymer compositions of the present disclosure comprise at least one melt processable thermoset polymer and at least one reinforcing filler. In another embodiment, a melt processable thermoset polymer composition optionally employs a variety of additives, which can enhance adhesion to support materials, thermal stability, mechanical properties and other desirable attributes.

A variety of melt processable thermoset polymers may be employed in a melt processable thermoset polymer composition. Non-limiting examples of melt processable thermoset polymers include epoxies, phenolics, urethanes, styrenics, isocyanates, melamine, methacrylate, lignin, tannin, polyimides, vinylic, amino, polyamidoamine, and cyanate esters. This may encompass one-part melt processable thermoset polymer systems containing a single curable monomer, or multipart system wherein two or more reactive species are used in conjunction to form the melt processable thermoset polymer composition. Non-limiting examples of melt processable thermoset polymers useful in this disclosure include 3M ScotchCast systems such as 5400, 260CG, 5230N, 5555, 260, 262, 263, and 265; Nagase-ChemTex XNR6850A with XNH6850B or XNH6850AY; Olin Solid Epoxy (such as DER 6155 or DER 672U) paired with Solid Hardener systems (such as DEH 80, DEH 84, or DEH 87; Plenco injection-moldable thermosets (including 6401, 6404, and 6406); Huntsman PKHB+ and other thermosetting phenolics.

A variety of reinforcing fillers may be employed in a melt processable thermoset polymer composition. A reinforcing filler or combination of fillers may impart certain physical properties including, but not limited to, increasing the viscosity or modulus of the material at elevated temperatures. Non-limiting examples of reinforcing fillers include nanomaterials that have a diameter of less than 200 nm and an aspect ratio greater than 10:1. Non-limiting examples of nanomaterials include single walled carbon nanotubes, multiwalled carbon nanotubes, functionalized carbon nanotubes, boron nitride nanotubes, boron nitride nanobarbs, ceramic nanotubes, ceramic nanorods, metal nanowires, metal oxide nanowires, metal oxide nanorods, inorganic nanowires, inorganic nanorods, nanostructured inorganic oxides, polymeric nanofibers, fibrous mineral species, cellulosic fibrils, etc. In other embodiments, a reinforcing filler includes carbon nanotubes such as those commercially manufactured by Nanocyl, Inc, sold commercially as grade NC7000, or those commercially manufactured by Kumho, Inc, sold commercially under the tradename K-Nanos.

A variety of different loading levels of melt processable thermoset polymer and reinforcing fillers can be employed in a melt processable thermoset polymer composition. In some embodiments, a melt processable thermoset polymer composition may, for example, include at least about 80 wt % melt processable thermoset polymer, or at least about 85 wt % melt processable thermoset polymer, or at least about 90 wt % melt processable thermoset polymer, or at least about 99.5 wt % melt processable thermoset polymer. In some embodiments, a melt processable thermoset polymer composition may, for example, include between 0.5 to 20 wt % of a reinforcing filler. In some embodiments, a melt processable thermoset polymer composition may include at least about 0.5 wt % reinforcing filler, or at least about 1 wt % reinforcing filler, or at least about 2 wt % reinforcing filler, or at least about 5 wt % reinforcing filler, or at least about 10 wt % reinforcing filler, and up to about 20 wt % reinforcing filler. In another embodiment, the melt processable thermoset polymer composition contains between 0.5 to 20 wt % of a reinforcing filler. In yet another embodiment, the melt processable thermoset polymer composition contains between 1 to 10 wt % of a reinforcing filler.

The melt processable thermoset polymer composition of this disclosure may optionally include additives to impart additional functionality. Non-limiting examples of suitable additives include stabilizers, carbohydrates, light stabilizers, antioxidants, secondary antioxidants, fibers, blowing agents, foaming additives, antiblocking agents, heat reflective materials, heat stabilizers, impact modifiers, biocides, antimicrobial additives, compatibilizers, plasticizers, tackifiers, processing aids, lubricants, slip agents, coupling agents, thermal conductors, electrical conductors, catalysts, flame retardants, oxygen scavengers, fluorescent tags, fillers, minerals, metals, and colorants. Additives may be incorporated into a melt processable thermoset polymer composition as a powder, liquid, pellet, granule, or in any other extrudable form. The amount and type of conventional additives in a melt processable thermoset polymer composition may vary depending upon the melt processable thermoset polymer and the desired properties of the finished composition. In view of this disclosure, a person having ordinary skill in the art will recognize that an additive and its amount can be selected in order to achieve desired properties in the finished material. Typical additive loading levels may be, for example, approximately 0.01 to 20 wt % of the composition formulation.

In another embodiment, the additive added to a melt processable thermoset polymer composition is a filler. Fillers are useful in that they allow one skilled in the art to adjust mechanical properties of the end-use article made using a polymeric material. Fillers can function to improve mechanical and thermal properties of the polymeric material. Fillers can also be utilized to reduce the coefficient of thermal expansion (CTE) of the polymeric article. Non-limiting examples of fillers include carbonates, silicates, talc, mica, wollastonite, clay, silica, alumina, carbon fiber, carbon black, graphite, graphene, volcanic ash, expanded volcanic ash, perlite, glass fiber, solid glass microspheres, hollow glass microspheres, cenospheres, ceramics, and conventional cellulosic materials including: wood flour, wood fibers, sawdust, wood shavings, newsprint, paper, flax, hemp, wheat straw, rice hulls, kenaf, jute, sisal, peanut shells, soy hulls, or any cellulose containing material. The amount of filler in a melt processable thermoset polymer composition after melt processing is typically between 1 to 60 wt %. In another embodiment, the filler loading level is between 1 to 50 wt %. In yet another embodiment, the filler loading level is between 1 to 30 wt %.

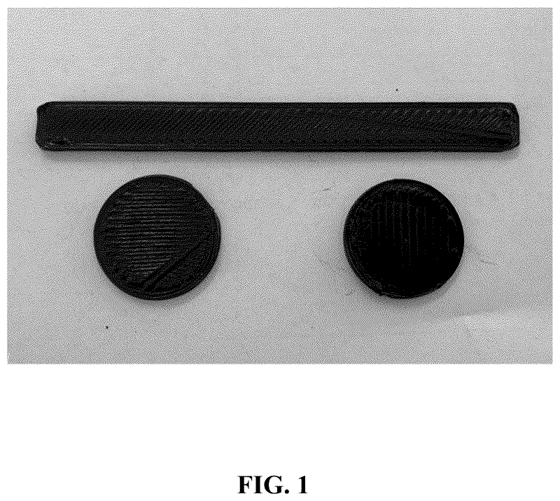

A melt processable thermoset polymer composition can be prepared by mixing, processing, or a combination thereof. Depending on the selected melt processable thermoset polymer, this can be done using a variety of mixing processes known to those skilled in the art in view of this disclosure. The melt processable thermoset polymer, reinforcing filler, and any optional additives can be combined, e.g., by a compounding mill, a Banbury mixer, or a mixing extruder. In another embodiment, a vented twin screw extruder is utilized. The materials may be used in the form of, for example, a powder, a pellet, a liquid, or a granular product. The mixing operation is most conveniently carried out at a temperature above the melt processing temperature of the melt processable thermoset polymer or the reinforcing filler, or above the melt processing temperatures of both the melt processable thermoset polymer and the reinforcing filler. The resulting melt processed melt processable thermoset polymer composition can be extruded directly into the form of the final product shape, or can be pelletized or fed from the melt processing equipment into a secondary operation to pelletize the composition (e.g., using a pellet mill or densifier) for later use. In another embodiment, the melt processable thermoset polymer composition and additives can be 3D printed directly. FIG. 1 shows a melt processable thermoset polymer composition that has been 3D printed.

A melt processable thermoset polymer composition can undergo additional processing for desired end-use applications. A melt processable thermoset polymer composition can be used as a feedstock in fused granulate frabrication (FGF). In some embodiments, the feedstock may be a granualte but other feedstocks (e.g., filament, film, sheet, shaped profile, powder, pellet, etc.) can also be used.

A melt processable thermoset polymer composition can be used in additive manufacturing as a build material, or as a support material to create a melt processable thermoset support. A melt processable thermoset polymer composition can also be converted into an article using conventional melt processing techniques, such as compounding, extrusion, molding, and casting, or other additive manufacturing processes. For use in additive manufacturing processes, a variety of additive manufacturing devices can employ melt processable thermoset polymer compositions as, for example, a melt processable thermoset support or build material. Non-limiting examples of such additive manufacturing devices include, but are not limited to, the Dremel DigiLab 3D45 3D Printer, LulzBot Mini 3D Printer, MakerBot Replicator+, XYZprinting da Vinci Mini, Ultimaker 3, Flashforge Finder 3D Printer, Robo 3D R1+Plus, Ultimaker 2+, Ultimaker S5, Titan Atlas, Arburg Freeformer 300X, Tumaker Bigfoot 350 Pro Dual, Tumaker NX Pro Dual, Intamsys 610, and AON M2.

In one embodiment, a method of producing a melt processable thermoset support includes melt processing at least one melt processable thermoset polymer and at least one reinforcing filler to form a melt processable thermoset polymer composition, converting the melt processable thermoset polymer composition into a 3D printing feedstock, and 3D printing the melt processable thermoset polymer composition to form a melt processable thermoset support.

In one embodiment, a method of producing a melt processable thermoset build material includes melt processing at least one melt processable thermoset polymer and at least one reinforcing filler to form a melt processable thermoset polymer composition, converting the melt processable thermoset polymer composition into a 3D printing feedstock, and 3D printing the melt processable thermoset polymer composition to form a melt processable thermoset build material.

In another embodiment, the 3D printed melt processable thermoset polymer composition may be substantially cured upon exposure to actinic energy (heat, radiation, or light).

A melt processable thermoset polymer composition can provide a number of advantages. For example, a melt processable thermoset polymer composition can be thermally stable at build chamber temperatures of at least about 20° C., or at least about 40° C., or at least about 60° C., or at least about 80° C., or at least about 100° C., or at least about 110° C., and up to about 120° C.

In some embodiments, a three-dimensional printed article includes a three-dimensional printed object generally deposited on a substantially horizontal build plate in a build chamber, and one or more supports, including a thermally stable melt processable thermoset polymer composition, positioned about and supporting one or more portions of the three-dimensional printed object. The melt processable thermoset polymer composition can be formed by melt processing a melt processable thermoset polymer and an reinforcing filler. In other embodiments, the build material of the three-dimensional printed article includes a melt processable thermoset polymer composition.

Thermally stable melt processable thermoset polymer compositions and articles including such compositions have broad utility in a number of industries, including, but not limited to, additive manufacturing. These compositions and articles can provide significant value to plastics compounders and converters. The disclosed compositions and articles offer enhanced properties, and increased modulus at higher temperatures. Non-limiting examples of articles produced from such compositions include, but are not limited to; medical supplies, automotive parts, structural parts, armor, tooling, fasteners and brackets, construction materials, and aerospace parts.

In the following examples, all parts and percentages are by weight unless otherwise indicated.

### Examples

TABLE 1
MATERIALS

| Material | Supplier |
|---|---|
| Melt processable thermoset Polymer | ScotchCast 5400; commercially available from 3M |
| 1 (MTP 1) | Corporation-Electrical Markets Division (Austin, |
| | TX) |
| Melt processable thermoset Polymer | ScotchCast 265; commercially available from 3M |
| 2 (MTP 2) | Corporation-Electrical Markets Division (Austin, |
| | TX). |
| Melt processable thermoset Polymer | PKHB+; commercially available from Huntsman |
| 3 (MTP 3) | Corporation (The Woodlands, TX) |
| Melt processable thermoset Polymer | Hexion Epon 1001F; commercially available from |
| 4 (MTP 4) | Miller-Stephenson (Danbury, CT) |
| Thermoplastic polymer 1 (TP1) | Polyox WSR N80, commercially available from |
| | Dupont (Wilmington, DE) |
| Thermoplastic polymer 2 (TP2) | Polyox WSR 301, commercially available from |
| | Dupont (Wilmington, DE) |
| Reinforcing Filler (RF1) | Nanocyl NC7000, multiwall carbon nanotubes, |
| | commercially available from Nanocyl, Inc. |
| | (Sambrville, Belgium) |
| Reinforcing Filler 1 (RF2) | K-Nanos 210T, multiwalled carbon nanotubes, |
| | commercially available from Kumho, Inc. |
| | (Chungcheonganam-do, Korea) |
| Filler 1 (F1) | Hyperplate T77 Talc, commercially available from |
| | Magris Talc, (Three Forks, MT) |
| Filler 2 (F2) | Carbon Fiber; commercially available from Zoltek |
| | (St. Louis, MO) |
| Filler 3 (F3) | Ensaco 250 Carbon Black, commercially available |
| | from Imerys (Willebroek, Belgium) |
| Filler 4 (F4) | Fumed Silica Cab-o-sil M5, Cabot (Boston, MA) |
| Filler 5 (F5) | Dicyandiamide, Sigma-Aldrich (Milwaukee, WI) |
| Filler 6 (F6) | Melamine, Sigma-Aldrich (Milwaukee, WI) |
| Filler 7 (F7) | Glass Bubbles S60HS 3M (Maplewood, MN) |

TABLE 2
EXPERIMENTAL FORMULATIONS

| | MTP1 | MTP2 | MTP3 | MTP4 | TP1 | TP2 | RF1 | RF2 | F1 | F2 | F3 | F4 | F5 | F6 | F7 |
|---|---|---|---|---|---|---|---|---|---|---|---|---|---|---|---|
| 1 | | | 9.0 | 90 | | | | | | | | | 1.0 | | |
| 2 | | | 9.0 | 90 | | | | | | | | | | 1.0 | |
| 3 | 50 | | | | 50 | | | | | | | | | | |
| 4 | 70 | | | | 30 | | | | | | | | | | |
| 5 | 80 | | | | 20 | | | | | | | | | | |
| 6 | 90 | | | | 10 | | | | | | | | | | |
| 7 | 80 | | | | 15 | | | | | | | 5 | | | |
| 8 | | 90 | | | | 10 | | | | | | | | | |
| 9 | | 80 | | | | 20 | | | | | | | | | |
| 10 | | 70 | | | | 30 | | | | | | | | | |
| 11 | | 95 | | | | | 5 | | | | | | | | |
| 12 | | 93.5 | | | | | 6.5 | | | | | | | | |
| 13 | | 92 | | | | | 8 | | | | | | | | |
| 14 | | 93 | | | | 2 | 5 | | | | | | | | |
| 15 | | 90 | | | | 2 | 8 | | | | | | | | |
| 16 | | 90 | | | | 5 | 5 | | | | | | | | |
| 17 | | 87 | | | | 5 | 8 | | | | | | | | |
| 18 | | 90 | | | | | 5 | | | | | | | | 5 |
| 19 | | 90 | | | | | 5 | | 5 | | | | | | |
| 20 | | 88 | | | | 2 | | 5 | 5 | | | | | | |
| 21 | | 91 | | | | 2 | | 5 | | 2 | | | | | |
| 22 | | 91 | | | | 2 | | 5 | | | 2 | | | | |
| 23 | | 100 | | | | | | | | | | | | | |
| 24 | 100 | | | | | | | | | | | | | | |

### Sample Preparation: Formulations 1-19

Each of Formulations 1-19 was prepared according to the weight ratios in Table 2. Formulations 1-19 were preblended and gravimetrically fed into a 11 mm corotating twin screw extruder (40:1 L: D, commercially available from Thermo Electron Gmbh, Karlsruhe, Germany). Compounding for formulations performed using the conditions provided in Table 3. The composite mixture was extruded and pelletized using a Thermo Electron pelletizer, into approximately 2.5 mm×2.5 mm cylindrical pellets, and collected.

TABLE 3
FORMULATION CONDITIONS

| | Z8 | Z7 | Z6 | Z5 | Z4 | Z3 | Z2 | Z1 | | Torque |
|---|---|---|---|---|---|---|---|---|---|---|
| Formulation | (° C.) | (° C.) | (° C.) | (° C.) | (° C.) | (° C.) | (° C.) | (° C.) | rpm | (%) |
| 1 | 190 | 190 | 190 | 190 | 190 | 190 | 190 | 190 | 100 | ~80 |
| 2 | 190 | 190 | 190 | 190 | 190 | 190 | 190 | 190 | 100 | ~80 |
| 3 | 100 | 100 | 100 | 100 | 100 | 100 | 100 | 100 | 150 | ~80 |
| 4 | 100 | 100 | 100 | 100 | 100 | 100 | 100 | 100 | 150 | ~80 |
| 5 | 100 | 100 | 100 | 100 | 100 | 100 | 100 | 100 | 150 | ~80 |
| 6 | 100 | 100 | 100 | 100 | 100 | 100 | 100 | 100 | 150 | ~80 |
| 7 | 100 | 100 | 100 | 100 | 100 | 100 | 100 | 100 | 150 | ~80 |
| 8 | 105 | 110 | 110 | 100 | 100 | 100 | 100 | 50 | 75 | ~50 |
| 9 | 90 | 90 | 110 | 100 | 100 | 100 | 100 | 50 | 125 | ~70 |
| 10 | 90 | 90 | 110 | 100 | 100 | 100 | 100 | 50 | 175 | ~50 |
| 11 | 105 | 105 | 100 | 100 | 100 | 100 | 85 | 20 | 165 | ~60 |
| 12 | 105 | 105 | 100 | 110 | 100 | 100 | 85 | 20 | 165 | ~80 |
| 13 | 105 | 105 | 105 | 105 | 105 | 105 | 85 | 20 | 175 | ~80 |
| 14 | 110 | 110 | 100 | 110 | 110 | 110 | 100 | 20 | 300 | ~70 |
| 15 | 110 | 110 | 100 | 110 | 110 | 110 | 100 | 20 | 300 | ~80 |
| 16 | 110 | 110 | 100 | 110 | 110 | 110 | 100 | 20 | 300 | ~70 |
| 17 | 110 | 110 | 100 | 110 | 110 | 110 | 100 | 20 | 300 | ~80 |
| 18 | 100 | 100 | 100 | 100 | 100 | 100 | 100 | 100 | 100 | ~80 |
| 19 | 100 | 100 | 100 | 100 | 100 | 100 | 100 | 100 | 100 | ~80 |

### Sample Preparation: Formulation 20-22

Each of Formulations 20-22 was prepared according to the weight ratios in Table 2. Formulations 20-22 were preblended (MTP2 with TP2, and RF2 with F1, F2, or F3 respectively) and gravimetrically fed, using separate feeders, into a 27-mm corotating twin screw extruder (52:1 L: D, commercially available from Entek. Lebanon, Oregon, United States). Compounding for formulations were performed using the following temperature profile, Z1 (throat) and Z2 at 50° F., Z3 at 100° F., Z4-Z14 at 180° F., and a die temperature ranging from 200-240° F. The extruder's screw speed was about 220 rpm, dynamic vacuum was applied at Z10, and the output rate was about 20 lbs/hr. Die pressures were recorded at 350 to 700 psi, with extruder torque readings ranging from 62 to 84%. The composite mixture was extruded onto an air cooled belt conveyor, pelletized using a Bullet model 62 pelletizer available from Maag Group, Oberglatt, Switzerland, into approximately 2.5 mm×2.5 mm cylindrical pellets, classified and collected.

### 3D Printing of Formulations 11-22

For each of formulations 11-22, pellets were printed on a TuMaker NXPro pellet-fed printer using a 2 mm diameter nozzle. Prior to printing, STL files were processed using Simplify3D slicing software. The parts were printed with an inlet temperature of 100° C., outlet temperature of 120° C., a print speed of 5 mm/s, a layer height of 1 mm, and a flow value of 250 steps/mm. The parts were printed onto Scotch blue painters tape (3M) adhered to a glass print bed heated to 100° C. in an ambient chamber environment. Printed parts were thin disks with dimensions of 30 mm diameter×3 mm thickness.

### DSC Characterization: Temperature Sweeps

Differential scanning calorimetry (DSC) was performed on formulations 14, and 20-24. All samples were heated from room temperature to 225° C. at a ramp rate of 10° C./min in air. Table 4 shows the results of this characterization, specifically key DSC glass transition temperatures (Tg), melting temperatures (Tm), and onset of exothermic cure.

TABLE 4
DSC ON FORMULATIONS 14 and 20-24

| | Glass Transition (Tg) | Melting | Exothermic |
|---|---|---|---|
| | Temperature | Temperature | cure onset |
| Formulation | (° C., Onset) | (° C.) | (° C.) |
| 14 | Not detected | 55 | 156 |
| 20 | 72 | 57 | 147 |
| 21 | 95 | 50 | 152 |
| 22 | 93 | 50 | 152 |
| 23 | 104 | 75 | 142 |
| 24 | 104 | 75 | 130 |

### DSC Characterization: Isothermal Measurements

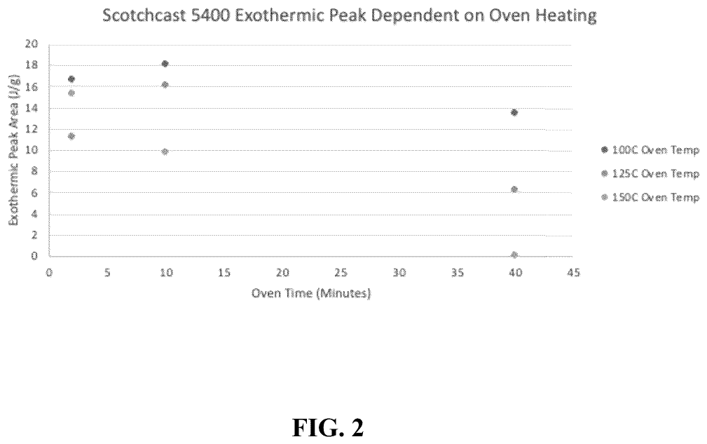

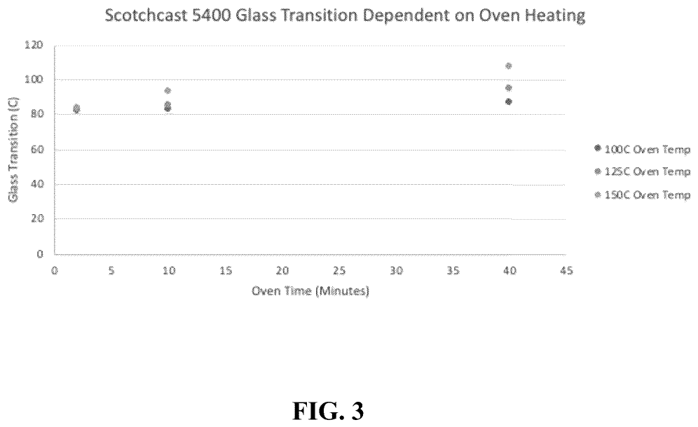

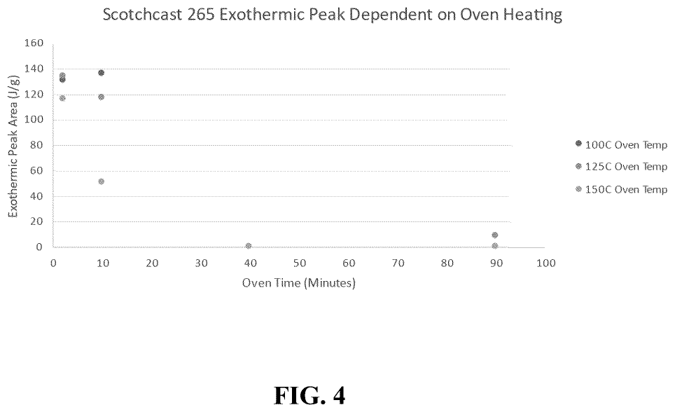

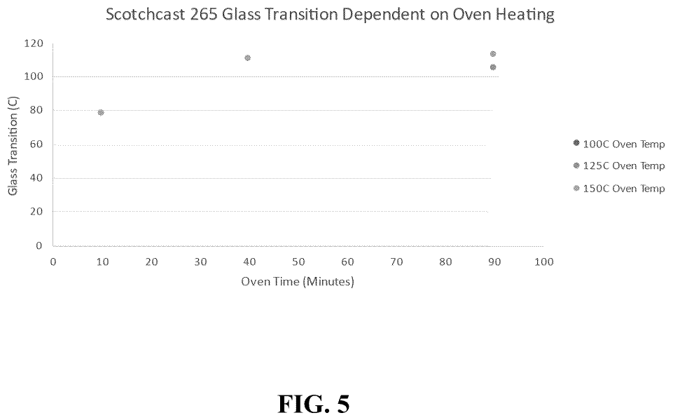

Differential scanning calorimetry (DSC) was performed on approximately 10 mg of formulations 14, and 20-24. The samples were held at either 100° C., 125° C., and 150° C. for either 2, 10, and 40 minutes before undergoing a temperature sweep from the hold temperature to 250° C. to determine glass transition temperature and remaining cure (determined by the area underneath the exothermic peak). All combinations of isothermal temperature and hold time were collected. FIG. 2 shows the area beneath the exothermic peak after isothermally holding ScotchCast 5400 samples at different temperatures for different durations. FIG. 3 shows the glass transition temperature after isothermally holding ScotchCast 5400 samples at different temperatures for different durations. FIG. 4 shows the area beneath the exothermic peak after isothermally holding ScotchCast 265 samples at different temperatures for different durations. FIG. 5 shows the glass transition temperature after isothermally holding ScotchCast 265 samples at different temperatures for different durations.

### Coefficient of Thermal Expansion (CTE) Characterization

Coefficient of thermal expansion measurements was performed on 3D printed and thermally cured (150° C. for 24 hours) formulations 14-22 using a Coefficient of Thermal Expansion Tester (commercially available from Analysis Tech, Wakefield, MA). All Formulations were analyzed from 25 to 75° C. and 75 to 25° C. Table 5 shows the results of this characterization.

TABLE 5
COEFFICIENT OF THEMAL EXPANSION (CTE)
RESULTS FOR FORMULATIONS 14-22.

| | Coefficient of thermal |
|---|---|
| Formulation | Expansion (in/in-° C.) |
| 14 | 5.14E−05 |
| 15 | 4.90E−05 |
| 16 | 4.99E−05 |
| 17 | 4.82E−05 |
| 18 | 4.73E−05 |
| 19 | 3.96E−05 |
| 20 | 4.21E−05 |
| 21 | 3.24E−05 |
| 22 | 3.98E−05 |

### Parallel Plate Dynamic Mechanical Analysis Characterization

Parallel Plate Dynamic Mechanical Analysis (PP-DMA) was performed on formulations 20-23 using an Anton-Paar MCR702 (Commercially available from Anton-Paar, Graz, Austria). Pellets of formulations 20-23 were melted at 85° C. and pressed between two disposable aluminum plates to a nominal gap of 2.4 mm. The samples were cooled to 25° C. and subsequently analyzed from 50 to 200° C. at a ramp rate of 2° C./min, an oscillating strain rate of 0.01% to 0.03%, and a frequency of 1 Hz. Table 6 shows the results of this characterization, specifically storage modulus at specific temperatures; Table 7 shows the loss modulus at specific temperatures; and Table 8 shows the complex viscosity at specific temperatures.

TABLE 6
PARALLEL PLATE DYNAMIC MECHANICAL ANALYSIS
STORAGE MODULUS AT TEMPERATURE RESULTS
FOR FORMULATIONS 20-23.

| | 50° C. | 100° C. | 125° C. | 150° C. | 175° C. |
|---|---|---|---|---|---|
| | Modulus | Modulus | Modulus | Modulus | Modulus |
| Formulation | (Pa) | (Pa) | (Pa) | (Pa) | (Pa) |
| 20 | 5.99E+06 | 5.40E+05 | 4.38E+05 | 6.65E+05 | 2.84E+06 |
| 21 | 1.32E+07 | 1.05E+06 | 6.66E+05 | 1.09E+06 | 3.48E+06 |
| 22 | 1.34E+07 | 1.20E+06 | 6.91E+05 | 1.17E+06 | 4.34E+06 |
| 23 | 6.57E+06 | 3.51E+02 | 1.24E+02 | | |

TABLE 7
PARALLEL PLATE DYNAMIC MECHANICAL
ANALYSIS LOSS MODULUS AT TEMPERATURE
RESULTS FOR FORMULATIONS 20-23.

| | 50° C. | 100° C. | 125° C. | 150° C. | 175° C. |
|---|---|---|---|---|---|
| | Modulus | Modulus | Modulus | Modulus | Modulus |
| Formulation | (Pa) | (Pa) | (Pa) | (Pa) | (Pa) |
| 20 | 1.08E+06 | 1.86E+05 | 1.25E+05 | 1.54E+05 | 2.14E+05 |
| 21 | 3.73E+05 | 4.14E+05 | 2.15E+05 | 2.32E+05 | 2.42E+05 |
| 22 | 1.43E+06 | 5.07E+05 | 2.28E+05 | 2.61E+05 | 2.72E+05 |
| 23 | 1.65E+05 | 3.80E+03 | 7.15E+02 | | |

TABLE 8
PARALLEL PLATE DYNAMIC MECHANICAL ANALYSIS
COMPLEX VISCOSITY AT TEMPERATURE RESULTS
FOR FORMULATIONS 20-23.

| | 50° C. | 100° C. | 125° C. | 150° C. | 175° C. |
|---|---|---|---|---|---|
| | Viscosity | Viscosity | Viscosity | Viscosity | Viscosity |
| Formulation | (mPa-s) | (mPa-s) | (mPa-s) | (mPa-s) | (mPa-s) |
| 20 | 9.69E+08 | 9.10E+07 | 7.24E+07 | 1.09E+08 | 4.54E+08 |
| 21 | 2.10E+09 | 1.80E+08 | 1.11E+08 | 1.77E+08 | 5.55E+08 |
| 22 | 2.15E+09 | 2.07E+08 | 1.16E+08 | 1.90E+08 | 6.92E+08 |
| 23 | 1.05E+09 | 6.08E+05 | 1.15E+05 | | |

### Isothermal Parallel Plate Dynamic Mechanical Analysis Characterization

Isothermal Parallel Plate Dynamic Mechanical Analysis (PP-DMA) was performed on formulations 11-13 and 20-23 using an Anton-Paar MCR702 (Commercially available from Anton-Paar, Graz, Austria). Pellets of formulations 11-13 and 20-23 were melted at 85° C. and pressed between two disposable aluminum plates to a nominal gap of 2.4 mm. The samples were heated 35° C./min to an isothermal temperature of 125° C., and analyzed for a period of 1 hour at an oscillating strain rate of 0.03% and a frequency of 1 Hz. Table 9 shows the results of this characterization, specifically storage modulus at specific times; Table 10 shows the loss modulus at specific times; and Table 11 shows the complex viscosity at specific times.

TABLE 9
ISOTHERMAL PARALLEL PLATE DYNAMIC MECHANICAL
ANALYSIS STORAGE MODULUS AT 125° C. AND
TIME (t) RESULTS FOR FORMULATIONS 11-13 AND 20-23.

| | 15 minutes | 30 minutes | 45 minutes | 60 minutes |
|---|---|---|---|---|
| Formulation | (Pa) | (Pa) | (Pa) | (Pa) |
| 11 | 1.85E+05 | 3.31E+05 | 8.35E+05 | 1.78E+06 |
| 12 | 2.10E+05 | 3.42E+05 | 6.66E+05 | 1.25E+06 |
| 13 | 6.14E+05 | 9.48E+05 | 1.66E+06 | 2.85E+06 |
| 20 | 4.03E+05 | 7.01E+05 | 1.20E+06 | 1.78E+06 |
| 21 | 5.28E+05 | 1.07E+06 | 1.80E+06 | 2.51E+06 |
| 22 | 4.81E+05 | 1.04E+06 | 1.90E+06 | 2.77E+06 |
| 23 | 8.10E+01 | 3.93E+04 | 5.62E+05 | 1.49E+06 |

TABLE 10
ISOTHERMAL PARALLEL PLATE DYNAMIC MECHANICAL
ANALYSIS LOSS MODULUS AT 125° C. AND TIME
(t) RESULTS FOR FORMULATIONS 11-13 AND 20-23.

| | 15 minutes | 30 minutes | 45 minutes | 60 minutes |
|---|---|---|---|---|
| Formulation | (Pa) | (Pa) | (Pa) | (Pa) |
| 11 | 5.29E+04 | 1.08E+05 | 2.62E+05 | 4.60E+05 |
| 12 | 5.67E+04 | 9.52E+04 | 1.86E+05 | 3.06E+05 |
| 13 | 1.64E+05 | 2.52E+05 | 4.40E+05 | 6.76E+05 |
| 20 | 1.07E+05 | 1.77E+05 | 2.50E+05 | 3.02E+05 |
| 21 | 1.53E+05 | 2.70E+05 | 3.67E+05 | 4.26E+05 |
| 22 | 1.46E+05 | 2.84E+05 | 4.22E+05 | 5.14E+05 |
| 23 | 1.32E+03 | 4.11E+04 | 2.22E+05 | 4.10E+05 |

TABLE 11
ISOTHERMAL PARALLEL PLATE DYNAMIC MECHANICAL
ANALYSIS COMPLEX VISCOSITY AT 125° C. AND
TIME (t) RESULTS FOR FORMULATIONS 11-13 AND 20-23.

| | Complex | Complex | Complex | Complex |
|---|---|---|---|---|
| | Viscosity 15 | Viscosity 30 | Viscosity 45 | Viscosity 60 |
| | minutes | minutes | minutes | minutes |
| Formulation | (mPa-s) | (mPa-s) | (mPa-s) | (mPa-s) |
| 11 | 3.06E+07 | 5.55E+07 | 1.39E+08 | 2.93E+08 |
| 12 | 3.46E+07 | 5.65E+07 | 1.10E+08 | 2.04E+08 |
| 13 | 1.01E+08 | 1.56E+08 | 2.73E+08 | 4.66E+08 |
| 20 | 6.64E+07 | 1.15E+08 | 1.95E+08 | 2.87E+08 |
| 21 | 8.74E+07 | 1.75E+08 | 2.92E+08 | 4.05E+08 |
| 22 | 8.00E+07 | 1.72E+08 | 3.10E+08 | 4.48E+08 |
| 23 | 2.10E+05 | 9.05E+06 | 9.62E+07 | 2.46E+08 |

### Gel Times

Gel-times for formulations 20-23 were estimated by analysis of the isothermal dynamic mechanical analysis data, as the time at which the storage modulus reached 250% of the minimum storage modulus at 125° C. Gel-times for formulations 20-23 were also estimated as the time at which the complex viscosity reached 250% of the minimum complex viscosity at 125° C. The results are shown in Table 12.

TABLE 12
ESTIMATED GEL TIMES AT 125°
C. FOR FORMULATIONS 20-23.

| | Minimum | Minimum | Est. Gel Time | Est. Gel Time |
|---|---|---|---|---|
| | Storage | Complex | based on Stor. | based on |
| | Modulus | Viscosity | Mod. | Comp. Visc. |
| Formulation | (Pa) | (mPa-s) | (min) | (min) |
| 20 | 3.35E+05 | 5.64E+07 | 23 | 23 |
| 21 | 2.68E+05 | 4.53E+07 | 23 | 23 |
| 22 | 2.49E+05 | 4.18E+07 | 26 | 27 |
| 23 | 2.27E+01 | 1.12E+05 | 30 | 30 |

### Determination of Thixotropic Index Through Parallel Plate Dynamic Mechanical Analysis

Isothermal Parallel Plate Dynamic Mechanical Analysis (PP-DMA) was performed on formulations 20-22 using an Anton-Paar MCR702 (Commercially available from Anton-Paar, Graz, Austria). Pellets of formulations 20-22 were melted at 85° C. and pressed between two disposable aluminum plates to a nominal gap of 2.4 mm. The samples were heated 35° C./min to an isothermal temperature of 100° C., and analyzed over a range of oscillating strain values from 0.0001592% to 0.001592% (corresponding to shear rates of 0.001 sec⁻¹ to 0.0001 sec⁻¹). Table 13 shows the shows the complex viscosity at specific values, and the thixotropic index. The thixotropic index is defined as the ratio of complex viscosity for the specified formulation at a shear value of 0.001 sec⁻¹ and 0.0001 sec⁻¹ at a temperature of 100° C.

TABLE 13
COMPLEX VISCOSITY AND THIXOTROPIC INDEX
FOR FORMULATIONS 20-22 AT 100° C.

| | Complex | Complex | |
|---|---|---|---|
| | Viscosity | Viscosity | Thixotropic |
| | @ 0.001 sec⁻¹ | @ 0.0001 sec⁻¹ | Index |
| Formulation | (mPa-s) | (mPa-s) | (unitless) |
| 20 | 2.36E+05 | 2.31E+05 | 0.98 |
| 21 | 4.77E+05 | 4.77E+05 | 0.99 |
| 22 | 3.35E+05 | 3.12E+05 | 0.93 |

### Laser Curing of Formulations

A Sainsmart Genmitsu 3018 PROVer upgraded with a 5.5 watt laser module was used to locally cure a representative sample (formulation 14). The 455 nm laser was focused to a 0.1 mm circle, and programmed to raster across the top surface of printed samples to generate heat and facilitate accelerated thermoset curing. The sample was fixed 20 mm below the laser, corresponding to the laser's focal length. A 64 square mm area was rastered in a cross-hatched pattern, at 600 mm per minute at 100% laser power, on the top surface of a 1 mm thick printed sample. After laser exposure, DSC was performed on the sample to determine extent of cure based on residual reaction enthalpy. DSC thermograms were collected from 25° C. to 300° C. at a heating rate of 10° C. per minute under an atmosphere of dinitrogen and air. Data was collected on the raw material (formulation 23), formulation 14 (as formulated; no processing), formulation 14 (as extruded at 110° C. for 90 seconds); formulation 14 (as printed at 120° C. for 240 seconds), and formulation 14 (as laser cured for 20 passes at 100% power output). Residual enthalpy was calculated as area under the exotherm centered at ˜180° C., measured from 120° C. to 235° C. (Table 14). Based on the results it is concluded that the melt processable thermoset composition is fully cured.

TABLE 14
RESIDUAL ENTHALPY AND PERCENT CURE

| | Process | Process | Residual | | Un- |
|---|---|---|---|---|---|
| Formulation | Temperature | Time | Enthalpy | Cured | cured |
| (process stage) | (° C.) | (seconds) | (J/g) | (%) | (%) |
| 23 | n/a | | 131.3 | 0 | 100 |
| 14 | n/a | | 122.1 | 0 | 100 |
| as formulated | | | | | |
| 14 | 110 | 90 | 114.7 | 6.1 | 93.9 |
| as extruded | | | | | |
| 14 | 120 | 240 | 78.3 | 35.9 | 64.1 |
| as printed | | | | | |
| 14 | 20 passes, 100% power | | 0 | 100 | 0 |
| laser cured | | | | | |

Having thus described particular embodiments, those of skill in the art will readily appreciate that the teachings found herein may be applied to yet other embodiments within the scope of the claims hereto attached.

What is claimed is:

1. A melt processable thermoset polymer composition comprising:
at least one melt processable thermoset polymer;
wherein the composition has a complex viscosity greater than 1×10⁵ mPa-s at 100° C. and a thixotropic index less than 5.

2. The melt processable thermoset polymer composition of claim 1, further comprising a reinforcing filler.

3. The melt processable thermoset polymer composition of claim 2, wherein the reinforcing filler is carbon nanotubes.

4. The melt processable thermoset polymer composition of claim 1, wherein the melt processable thermoset polymer is an epoxy based polymer.

5. The melt processable thermoset polymer composition of claim 1, further comprising one or more additives.

6. The melt processable thermoset polymer composition of claim 5, wherein the additive is a filler.

7. The melt processable thermoset polymer composition of claim 6, wherein the filler is carbon fiber.

8. The melt processable thermoset polymer composition of claim 1, wherein the melt processable thermoset polymer composition is thermally stable at a build chamber temperature of 80° C.

9. The melt processable thermoset polymer composition of claim 1, wherein the melt processable thermoset polymer composition is thermally stable at a build chamber temperature of 100° C.

10. The melt processable thermoset polymer composition of claim 1, wherein the melt processable thermoset polymer composition is thermally stable at a build chamber temperature of 120° C.

11. The melt processable thermoset polymer composition of claim 1, wherein the melt processable thermoset polymer composition has a coefficient of thermal expansion less than 5.14E-05 inch per inch per ° C.

12. The melt processable thermoset polymer composition of claim 1, wherein the melt processable thermoset polymer composition forms a feedstock.

13. The melt processable thermoset polymer composition of claim 12, wherein the feedstock is a pellet.

14. An article comprising the melt processable thermoset polymer composition of claim 1.

15. A method of producing a melt processable thermoset support comprising:
melt processing at least one melt processable thermoset polymer and at least one reinforcing filler to form a melt processable thermoset polymer composition;
converting the melt processable thermoset polymer composition into a 3D printing feedstock; and
3D printing the melt processable thermoset polymer composition to form a melt processable thermoset support.

16. A method of producing a melt processable thermoset build material comprising:
melt processing at least one melt processable thermoset polymer and at least one reinforcing filler to form a melt processable thermoset polymer composition;
converting the melt processable thermoset polymer composition into a 3D printing feedstock; and
3D printing the melt processable thermoset polymer composition to form a melt processable thermoset build material.

17. The method of claim 15, wherein the step of 3D printing forms an article.

18. The method of claim 15, wherein the 3D printed melt processable thermoset polymer composition may be substantially cured upon exposure to actinic energy.

19. A three-dimensional printed article comprising:
a three-dimensional printed object generally deposited on a substantially horizontal build plate in a build chamber; and
one or more supports positioned about and supporting one or more portions of the three-dimensional printed object;
wherein the one or more supports comprise a melt processable thermoset polymer composition;
wherein the melt processable thermoset polymer composition is formed by melt processing at least one melt processable thermoset polymer and at least one reinforcing filler.

20. The three-dimensional printed article of claim 19, wherein the melt processable thermoset polymer composition is a build material.
